(19) United States
(12) Patent Application Publication
(10) Pub. No.: US 2024/0054368 A1
(43) Pub. Date: Feb. 15, 2024

(54) GEOGRAPHIC DISTRIBUTION OF RESOURCES USING GENETIC ALGORITHMS

(71) Applicant: WORKDAY, INC., Pleasanton, CA (US)

(72) Inventors: Volodymyr TOMENKO, Pleasanton, CA (US); Dalmo CIRNE, Boulder, CO (US); Ganesh RAJARATNAM, Pleasanton, CA (US); Chris CHEN, Pleasanton, CA (US)

(21) Appl. No.: 17/818,472

(22) Filed: Aug. 9, 2022

(51) Int. Cl. G06N 5/04; G06N 3/12

(52) U.S. Cl. CPC G06N 5/041; G06N 3/126

(57) ABSTRACT

In some aspects, the techniques described herein relate to a method including: initializing a population of hypotheses; computing misfit values for each of the hypotheses, the misfit values computed using a fitness function including a weighted summation, wherein terms of weighted summation include metric functions; generating a plurality of offspring hypotheses based on the population of hypotheses and a crossover bitmask; generating a new population using the plurality of offspring and a subset of the population of hypotheses; mutating at least one hypothesis in the new population; selecting a hypothesis from the new population based on a corresponding misfit value of the hypothesis; and allocating at least one resource based on the hypothesis.

### BACKGROUND

Organizations have the need to optimize the allocation of resources (e.g., employees, hardware, services, etc.) within a given geographic region. Generally, resources situated within geographically optimized networks perform better and, as a result, provide the most benefits. Therefore, constructing optimal or optimizing existing allocations of resources leads to the improvement of the performance of resources and reduction of expenses.

Existing solutions for allocating resources are not flexible in the sense they aim to optimize only a strictly limited subset of objectives. For example, classical clustering algorithms optimize geographical territories with respect to minimal traveling distances, while balanced clustering algorithms balance geographical territories with respect to a number of serviceable objects (e.g., customers). Moreover, for objectives like finding geographical territories balanced with respect to key performance indicators, globally optimal algorithms have not been developed. As such, the distribution of resources within a geographic region is inflexible and sub-optimal.

### BRIEF DESCRIPTION OF THE DRAWINGS

FIG. 1 is a block diagram illustrating a system for identifying a set of geographic clusters.

FIG. 2 is a flow diagram illustrating a method for identifying a set of geographic clusters.

FIG. 3 provides a graphical representation of applying a fitness function to a set of hypotheses.

FIG. 4 is a flow diagram illustrating a method for generating offspring hypotheses from parent hypotheses.

FIG. 5 is a flow diagram illustrating a method for mutating a population of hypotheses.

FIG. 6 is a block diagram illustrating sample rows of a database.

FIG. 7 is a block diagram of a computing device.

### DETAILED DESCRIPTION

The disclosure relates to the optimal geographical organization and, as the result, optimal assignment of resources as part of a territory planning process. During this process, small geographic areas are aggregated into larger territories, larger territories aggregates are grouped into geographically contiguous clusters, and resources are assigned to resulting clusters.

In some aspects, the techniques described herein relate to a method including: initializing a population of hypotheses; computing misfit values for each of the hypotheses, the misfit values computed using a fitness function including a weighted summation, wherein terms of weighted summation include metric functions; generating a plurality of offspring hypotheses based on the population of hypotheses and a crossover bitmask; generating a new population using the plurality of offspring and a subset of the population of hypotheses; mutating at least one hypothesis in the new population; selecting a hypothesis from the new population based on a corresponding misfit value of the hypothesis; and allocating at least one resource based on the hypothesis.

In some aspects, the techniques described herein relate to a method, wherein initializing a population of hypotheses includes generating a set of hypotheses, each hypotheses including a set of latitude-longitude pairs.

In some aspects, the techniques described herein relate to a method, wherein each latitude-longitude pair in the set of latitude-longitude pairs includes a randomized numeric latitude-longitude pair.

In some aspects, the techniques described herein relate to a method, wherein the metric functions include a cluster quality function.

In some aspects, the techniques described herein relate to a method, wherein the cluster quality function includes one of a k-means objective function, Davies-Bouldin index, or Silhouette coefficient.

In some aspects, the techniques described herein relate to a method, wherein generating a given offspring hypothesis includes: selecting two hypotheses from the population of hypotheses; generating a random bitstring as the crossover bitmask; and applying the random bitstring to each of the two hypotheses to generate two offspring hypotheses.

In some aspects, the techniques described herein relate to a method, further including generating the subset of the population of hypotheses via tournament selection.

In some aspects, the techniques described herein relate to a method, wherein mutating at least one hypothesis in the new population includes adjusting a gene in the at least one hypothesis using a normal distribution.

In some aspects, the techniques described herein relate to a method, wherein a width parameter of the normal distribution varies based on a number of iterations of mutation.

In some aspects, the techniques described herein relate to a non-transitory computer-readable storage medium for tangibly storing computer program instructions capable of being executed by a computer processor, the computer program instructions defining the steps of: initializing a population of hypotheses; computing misfit values for each of the hypotheses, the misfit values computed using a fitness function including a weighted summation, wherein terms of weighted summation include metric functions; generating a plurality of offspring hypotheses based on the population of hypotheses and a crossover bitmask; generating a new population using the plurality of offspring and a subset of the population of hypotheses; mutating at least one hypothesis in the new population; selecting a hypothesis from the new population based on a corresponding misfit value of the hypothesis; and allocating at least one resource based on the hypothesis.

In some aspects, the techniques described herein relate to a non-transitory computer-readable storage medium, wherein initializing a population of hypotheses includes generating a set of hypotheses, each hypotheses including a set of latitude-longitude pairs.

In some aspects, the techniques described herein relate to a non-transitory computer-readable storage medium, wherein each latitude-longitude pair in the set of latitude-longitude pairs includes a randomized numeric latitude-longitude pair.

In some aspects, the techniques described herein relate to a non-transitory computer-readable storage medium, wherein the metric functions include a cluster quality function.

In some aspects, the techniques described herein relate to a non-transitory computer-readable storage medium, wherein the cluster quality function includes one of a k-means objective function, Davies-Bouldin index, or Silhouette coefficient.

In some aspects, the techniques described herein relate to a non-transitory computer-readable storage medium, wherein generating a given offspring hypothesis includes: selecting two hypotheses from the population of hypotheses; generating a random bitstring as the crossover bitmask; and applying the random bitstring to each of the two hypotheses to generate two offspring hypotheses.

In some aspects, the techniques described herein relate to a non-transitory computer-readable storage medium, further including generating the subset of the population of hypotheses via tournament selection.

In some aspects, the techniques described herein relate to a non-transitory computer-readable storage medium, wherein mutating at least one hypothesis in the new population includes adjusting a gene in the at least one hypothesis using a normal distribution.

In some aspects, the techniques described herein relate to a non-transitory computer-readable storage medium, wherein a width or standard deviation parameter of the normal distribution varies based on a number of iterations of mutation.

In some aspects, the techniques described herein relate to a system including: a processor; and a storage medium for tangibly storing thereon program logic for execution by the processor, the stored program logic including instructions for: initializing a population of hypotheses; computing misfit values for each of the hypotheses, the misfit values computed using a fitness function including a weighted summation, wherein terms of weighted summation include metric functions; generating a plurality of offspring hypotheses based on the population of hypotheses and a crossover bitmask; generating a new population using the plurality of offspring and a subset of the population of hypotheses; mutating at least one hypothesis in the new population; selecting a hypothesis from the new population based on a corresponding misfit value of the hypothesis; and allocating at least one resource based on the hypothesis.

In some aspects, the techniques described herein relate to a system, wherein the metric functions include a cluster quality function and at least one of a density balance function and key performance indicator function.

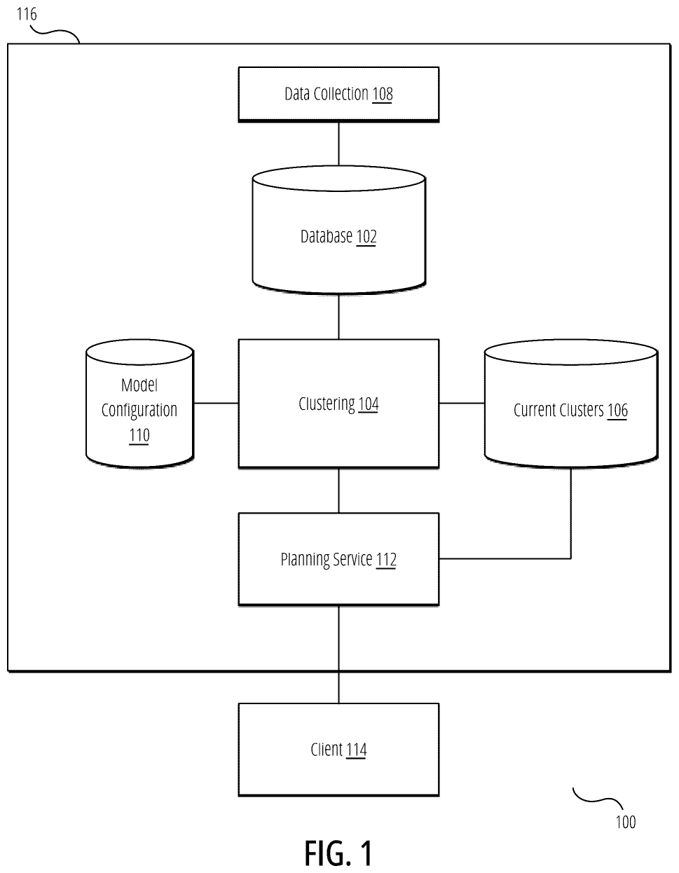

FIG. 1 is a block diagram illustrating a system for identifying a set of geographic clusters.

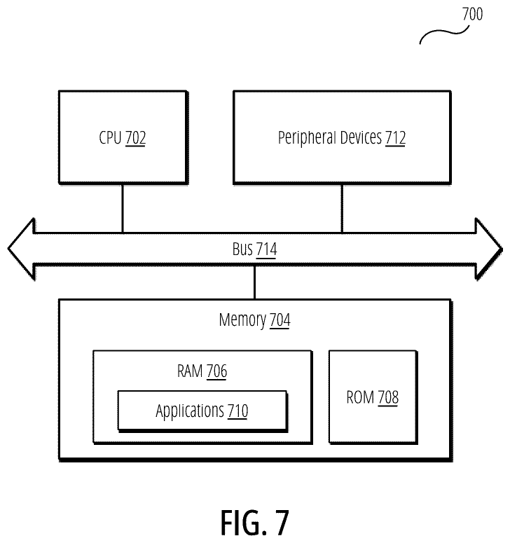

In the illustrated system 100, a client 114 communicates with a server platform 116 to obtain geographic clusters. In some implementations, client 114 may be a computing device such as that depicted in FIG. 7. In some implementations, server platform 116 may also be a computing device such as that depicted in FIG. 7. However, in other implementations, client 114 or server platform 116 may both include multiple computing devices operating together to perform the various functionalities described herein. Client 114 and server platform 116 may include physical or virtual computing resources or a combination of both. Client 114 and server platform 116 may communicate over any reasonable medium via one or more networks, such as the Internet.

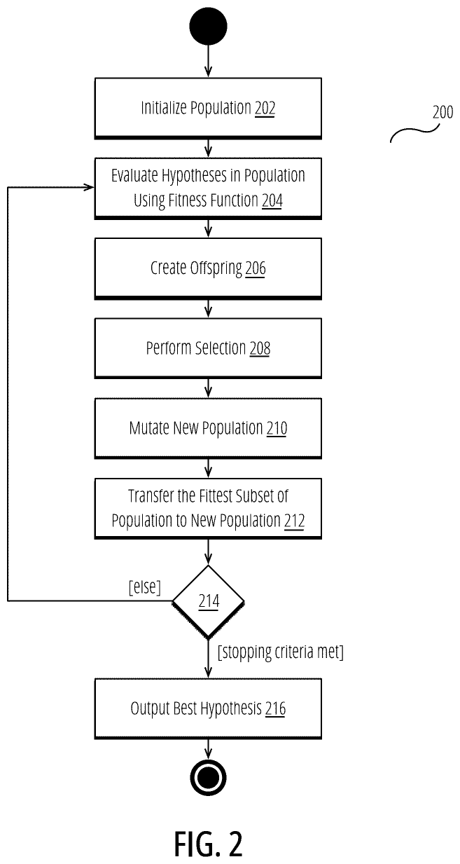

In some scenarios, client 114 may issue a network request to server platform 116 to obtain a set of geographic clusters. In some instances, this network request can include filters (e.g., in the form of query parameters) that can refine the scope of the request (e.g., by region, by time, etc.). In response, the server platform 116 can identify optimized geographic clusters and return data describing such clusters to the server platform 116, as described fully in the description of FIG. 2 through FIG. 5.

The server platform 116 can include a planning service 112. The planning service 112 can receive network requests from client 114 and provide responses (i.e., clusters) to client 114. In some implementations, the planning service 112 can be implemented as a web service or similar type of application layer service that can perform authentication, authorization, route handling, and other aspects of network request handling. As illustrated, planning service 112 can also issue requests to a clustering module 104. As will be described, the clustering module 104 can retrieve or generate optimized geographic clusters and return these clusters to the planning service 112, which can then forward the optimized geographic clusters to client 114.

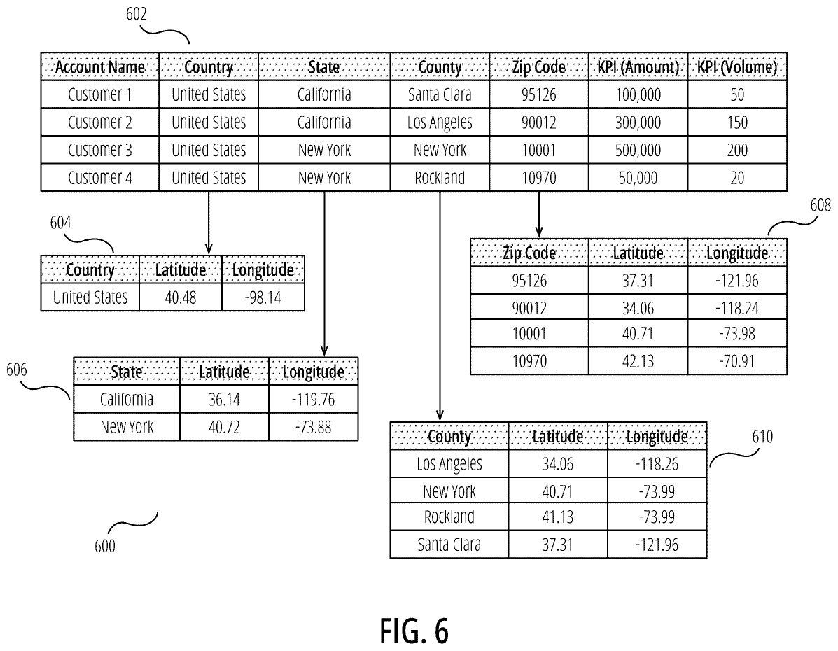

The clustering module 104 can perform some of all of the steps described in FIG. 2 through FIG. 5, which are not repeated herein. In brief, the clustering module 104 can access database 102 to obtain raw metric data. FIG. 6 is a non-limiting diagram of sample rows from such a database. As illustrated in FIG. 6, database 600 can include a table 602 that includes rows for a variety of accounts and corresponding regions (e.g., country, state, county, and zip code). For each combination of account and region, various key performance indicators (KPIs) can be stored. For example, each region-account pair includes a total sales amount KPI and a total sales volume KPI. In some implementations, a data collection service 108 may periodically update the data in table 602 based on observed data. In some embodiments, table 602 can be journaled, and thus past KPI measurements can be preserved.

In addition to raw data, the database 600 can include various views or aggregates (e.g., country aggregate 604, state aggregate 606, zip code aggregate 608, and county aggregate 610). An aggregate refers to a geographic region that encompasses one or more other regions. For example, country aggregate 604 represents entire countries while county aggregate 610 only represents entire counties. The aggregates can be used to generate aggregate KPI values. For example, all customer sales for the United States can be aggregated and associated with the country aggregate 604. Similarly, all sales in Los Angeles, New York, Rockland, and Santa Clara can be individually aggregated and stored in county aggregate 610. In this manner, the raw data in table 602 can be viewed at different geographic levels of granularity and also used as aggregates in clustering (described below). As illustrated, each aggregate is associated with a latitude and longitude, which may be the geographic center of the administrative region. In some embodiments, aggregates can be generated on-demand. In other embodiments, they may be pre-computed and cached for quicker access.

Returning to FIG. 1, clustering module 104 loads aggregates from access database 102 and generates a set of clusters that groups the aggregates. Each cluster is associated with a latitude and longitude value. The clustering module 104 loads model parameters from configuration store 110. The configuration store 110 can store operating parameters of a genetic algorithm executed by clustering module 104 (e.g., number of iterations, population size, a fraction of the new population to be populated by crossover, a fraction of the new population to be mutated, number of the fittest hypotheses to be transferred from current to a new population, initial width value for mutation, final width value for mutation). These parameters and their use are described more fully herein. Further, the configuration store 110 can also store metric functions that are used to assign misfit scores to candidate hypotheses in the genetic algorithm, as discussed in further detail herein.

In some scenarios, the clustering module 104 can load the model parameters from configuration store 110 and aggregates from access database 102 and can generate optimal clusters in response to a client request. In other scenarios, the clustering module 104 can generate optimal clusters on a periodic basis (e.g., at regular intervals such as the first of the month). In some scenarios, the clustering module 104 can store the optimal clusters in a current clusters database 106. In some embodiments, the planning service 112 can check the current clusters database 106 to determine if an up-to-date set of optimal clusters exists in current clusters database 106. If not, the planning service 112 can request the clustering module 104 re-generate the optimal clusters and can then access the clusters from current clusters database 106.

FIG. 2 is a flow diagram illustrating a method for identifying a set of geographic clusters.

In step 202, method 200 can include initializing a population. Step 202 can include identifying a pre-defined number (P) of hypotheses where each hypothesis includes a pre-defined number of genes. These genes can be randomly selected for each hypothesis.

In existing genetic algorithms, hypotheses are frequently represented as binary data, where each bit of a binary string corresponds to a gene. However, for numerical optimization problems, binary strings can frequently be suboptimal. Consider, for example, the binary value ‘100,’ which has a decimal value of four. In an ideal scenario, a mutation resulting in three or five should be equally likely. However, mutating the binary value ‘100’ to binary five (‘101’) requires only one bit mutation while mutating to binary three (‘011’) requires three mutations. As a result, the exploration of the possible solution space by the algorithm becomes suboptimal.

To overcome this technical deficiency in existing technical solutions, step 202 can include representing a given hypothesis using numeric genes. That is, in contrast to existing genetic algorithms, the genes used in step 202 can be non-binary. That is, for example, the genes can be represented as numeric data. As discussed previously, method 200 identifies an optimal set of M geographic clusters that minimize an objective function. These clusters can be represented via centroids. Thus, the optimal set of geographic clusters can be represented as a set of M tuples, each tuple including a latitude and a longitude pair. In step 202, a given hypothesis can be represented as a set of M randomly generated latitude-longitude pairs (e.g., ((lat₁, long₁),(lat₂, long₂), . . . (latₘ, longₘ))). When considering a given latitude or a given longitude (represented numerically) as a gene, each hypothesis can thus include 2M numeric genes.

Thus, returning to step 202, to generate P hypotheses, method 200 can generate 2*M*P random numeric values that are used to build the latitude-longitude pairs for each hypothesis.

In step 204, method 200 can include evaluating the hypotheses in the population using a fitness function.

The fitness function can include a function that evaluates the fitness (e.g., quality) of a hypothesis as a candidate solution in a population. In some implementations, fitness function can assign a ‘misfit’ value to a given hypothesis. Lower misfit values can increase the probability of the corresponding hypothesis to be transferred to a new population (e.g., via a selection operator, discussed herein) and participate in generating offspring (e.g., via a crossover operator, as discussed herein).

In some implementations, the fitness function can be a weighted summation wherein the terms of summation are individual metric functions. As one example, the metric functions can include a cluster quality function (e.g., a k-means objective function, Davies-Bouldin index, Silhouette coefficient, etc.). As another example, the metric functions can include a density balance function. As another example, the metric functions can include a key performance indicator (KPI) function. These metric functions can be individually weighted and then summed to obtain the misfit value. In some implementations, the fitness function can include a weighted summation that includes the cluster quality function and one or more other metric functions.

One non-limiting example of a fitness function ( [symbol] ) is provided herein:

$$ℒ ( X , C ) = {w}_{1} {\sum }_{{c}_{j} ∈ C} {\sum }_{{x}_{i} ∈ A ( {c}_{j} )} {‖ {x}_{i} - {c}_{j} ‖}^{2} + {\sum }_{k = 1}^{K} {\sum }_{t = 1}^{T} {w}_{k}^{t} {P}_{k}^{t} ( X , C ) \qquad Equation 1$$

In Equation 1, the fitness function ( [symbol] ) takes, as inputs, a set of aggregates (X) and a population (C) (such as that generated in step 202). The set of aggregates can be represented as X={xᵢ, x₂, . . . xₙ} where a given aggregate xᵢ is represented as latitude and longitude for a given aggregate (e.g., region) and a set of KPI values (KPI₁, KPI₂, KPI_{T}) where each KPI value is an aggregated value (e.g., sum) of corresponding KPI values of customer accounts which are rolled up to a given aggregate. As will be discussed, the fitness function can penalize hypotheses with centroids falling outside of the allowed latitude-longitude ranges defined by extreme values derived from aggregates.

The first term of Equation 1 is a k-means objective function. In this function, A(cⱼ) represents an assignment function which, given a centroid cⱼ produces a subset of aggregates assigned to this centroid (A(cⱼ):X→Xⱼ⊂X). As illustrated, the k-means objective function can be weighted by a fixed weight (w₁).

The second term of Equation 1 is a weighted sum of penalty functions (Pₖ^{t}(X, C)), each penalty function assigned a fixed weight wₖ^{t}. In Equation 1, T represents a set of KPIs. Thus, the dual summation in the second term computes the values of penalty functions for each KPI (KPIₜ) and for each type of penalty function (k). As one example, the value of k may be set to two and a density balance function and KPI balance function may be used as the two penalty functions P₁^{t}(X, C) and P₂^{t}(X, C).

As one example, a density balance function P₁^{t}(X, C) can be represented as:

$${P}_{1}^{t} ( X , C ) = {\sum }_{{c}_{j} ∈ C} [ \frac{\vert X \vert}{\vert C \vert} - \vert A ( {c}_{j} ) \vert ] \qquad Equation 2$$

In Equation 2, the penalty function computes a sum of deviations from the average number of aggregates per cluster. As another example, a KPI balance function P₂^{t}(X ,C) can be represented as:

$${P}_{2}^{t} ( X , C ) = {\sum }_{{c}_{j} ∈ C} [ \frac{1}{\vert C \vert} {\sum }_{{x}_{i} ∈ X} {KPI}_{t}^{{x}_{i}} - {\sum }_{{x}_{i} ∈ A ( {c}_{j} )} {KPI}_{t}^{{x}_{i}} ] \qquad Equation 3$$

In Equation 3, the penalty function computes a sum of deviations from average aggregated KPIₜ per cluster. Certainly, other penalty functions may be designed and used alone or in combination, and the specification is not limited to only these penalty functions. Indeed, a benefit of the fitness function is that penalty functions can be used and combined as desired to meet the needs of the method or its users. For example, one such possible metric may calculate disparities between the planned sales volume and historical sales volumes for a given territory, thus providing realistic clusters in terms of sales targets.

Further, in some implementations, the weights of each of the metric functions can be tuned by the operator of method 200. A given user may wish to obtain different objectives such as (a) obtaining the best possible geographical clusters, thus, for example, reducing the travel distance between customers; (b) keeping clusters balanced so that each cluster has an approximately equal number of aggregates such that each sales representative will be assigned an approximately equal number of customers; (c) keeping rolled up KPIs (or a subset of KPIs) within clusters balanced so that each cluster has approximately equal value of rolled up KPIs such that each sales representative will be assigned for example approximately equal volume of sales; and/or (d) a combination of the foregoing. Such objectives can be reached by adjusting the weights of the cluster quality function (objective (a)) or the penalty functions (objectives (b) and (c)).

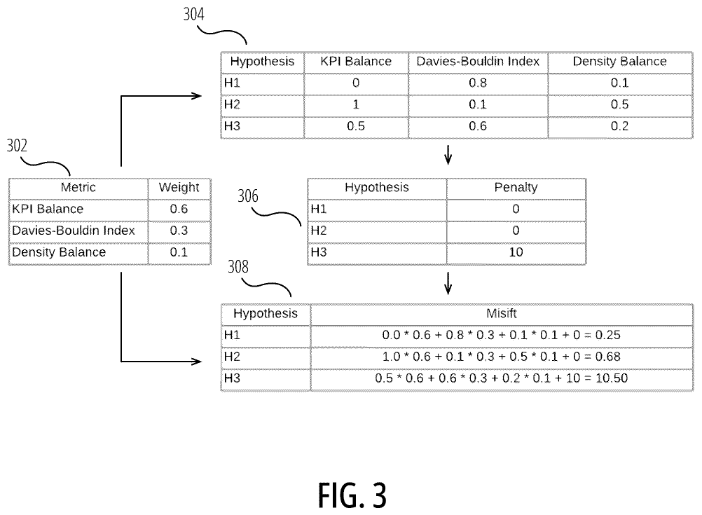

FIG. 3 provides a graphical representation of applying a fitness function to a set of hypotheses.

In the illustrated representation, three metric functions are used: a Davies-Bouldin index, KPI balance, and density balance. These functions are described previously, and details are not repeated herein. In table 302, each metric function is assigned a weight (e.g., 0.6 for the KPI balance, 0.3 for the Davies-Bouldin index, and 0.1 for the density balance). In some implementations, the sum of the weights is equal to one.

In table 304, the metric functions are applied to three example hypotheses. As one example, hypothesis H1 has a KPI balance of zero, a Davies-Bouldin index of 0.8, and a density balance of 0.1. Hypotheses H2 and H3 are analyzed in the same manner. In one implementation, as illustrated, the results in table 304 are standardized. For example, a min-max normalization can be used to normalize each value to a value between zero and one. Alternative normalization techniques (e.g., z-score normalization) may also be used.

In table 306, a penalty can be assigned to each hypothesis. In some implementations, a per-hypothesis penalty can be optional. If implemented, a penalty value is computed or otherwise determined by identifying hypotheses with centroids falling outside of allowed latitude-longitude ranges defined by extreme values derived from aggregates. In table 306, hypotheses H1 and H2 are given a zero penalty, while H3 is given a penalty of ten.

In table 308, misfit values for each hypothesis are computed. As discussed, in some implementations, the misfit values can be computed by weighting and summing the metric function results in table 304. Further, as illustrated, in some implementations, the misfit values can also include the penalty in table 306.

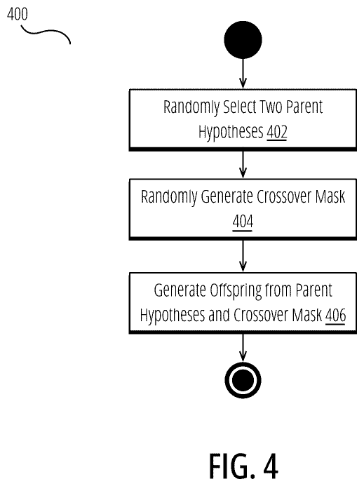

In step 206, method 200 can include generating or creating offspring hypotheses from the initialized population. In one implementation, step 206 can be implemented as a crossover operation of a genetic algorithm. In general, step 206 can include recombining genes (e.g., latitude or longitude values) of two parents from a current population (e.g., an initial population on the first run) to generate two offspring (i.e., hypotheses) for a new population. In this way, new candidate solutions can be generated stochastically from existing candidate solutions. Details of step 206 are provided next in connection with FIG. 4.

FIG. 4 is a flow diagram illustrating a method for generating offspring hypotheses from parent hypotheses.

In step 402, method 400 can include randomly selecting two parent hypotheses from a given population. In some implementations, the two parent hypotheses can be selected at random from the population. In other implementations, a selection operation (described in step 208 of FIG. 2) can be used to select two parent hypotheses. As described above, each parent hypothesis includes a set of genes, each gene being either a latitude or longitude value. For example, each parent can include M*2 genes, where M comprises a number of latitude-longitude pairs in a given hypothesis.

In step 404, method 400 can include generating a random crossover mask. In some implementations, the random crossover mask can be represented as a binary bit string. In some implementations, this bitstring has a length of M*2, matching the length of each parent hypothesis. In some implementations, the bitstring is randomly or pseudo-randomly generated for each set of parent hypotheses.

In step 406, method 400 can include generating two offspring from the parent hypotheses using the bitmask.

In one implementation, to generate offspring, method 400 can iterate through each bit of the random crossover mask. For each bit k, if the value of the bit is one, then gene k in offspring 1 will be taken from parent 1 and gene k in offspring 2 will be taken from parent 2. Conversely, if the entry value is 0, then gene k in offspring 1 will be taken from parent 2 and gene k in offspring 2 will be taken from parent 1.

As an example, consider two parent hypotheses (parent 1 and parent 2) that include four genes selected in step 402:

Parent 1

| | | | | |
|---|---|---|---|---|
| Gene No. | 0 | 1 | 2 | 3 |
| Value | 10 | 5 | 6 | 7 |

Parent 2

| | | | | |
|---|---|---|---|---|
| Gene No. | 0 | 1 | 2 | 3 |
| Value | 9 | 3 | 1 | 5 |

Next, a random crossover bitmask of ‘1010’ is generated in step 406. With these two parents and the random crossover bitmask, two offspring can be generated as follows:

| | Offspring 1 | | | |
|---|---|---|---|---|
| Gene No. | 0 | 1 | 2 | 3 |
| Value | 10 (Parent 1) | 3 (Parent 2) | 6 (Parent 1) | 5 (Parent 2) |

| | Offspring 2 | | | |
|---|---|---|---|---|
| Gene No. | 0 | 1 | 2 | 3 |
| Value | 9 (Parent 2) | 5 (Parent 1) | 1 (Parent 2) | 7 (Parent 1) |

Returning to FIG. 2, in step 206, method 200 can apply method 400 for a pre-defined number of times. For example, method 200 can execute method 400 rP times, P is the current population size and r is a tunable parameter that represents the fraction of the new population to be populated by crossover. In some implementations, the new population after step 206 only includes offspring generated via crossover and further hypotheses are added next, in step 208.

In step 208, method 200 can include selecting a subset of the current population of hypotheses for inclusion in the new population of hypotheses.

As discussed, after step 206, a new population is generated with rP offspring hypotheses generated via crossover. Next, a subset of the current population is selected for inclusion in the new population using a selection operator. In some implementations, the selection operator is used to transfer a portion of hypotheses from the current population to the new population. This operator probabilistically can select the fittest hypotheses as defined by a fitness function described previously. Probabilistically in this context means method 200 may prefer hypotheses with lower misfit values but still occasionally allow hypotheses with higher misfit values to keep diversity.

In one implementation, step 208 can include a tournament selection process. A tournament selection process can include randomly selecting two hypotheses from the current population. Next, step 208 can include comparing the misfit values of each of the two hypotheses and selecting the hypothesis having the lower misfit value. Given the random selection, it is thus possible that hypotheses having higher misfit values are still selected for the new population. Other types of selections other than tournament selection can be implemented.

Method 200 can select P−rP−e hypotheses from the current population (e.g., via tournament selection) for inclusion in the new population, where P is the current population size, rP is the number of offspring generated in step 206, and e represents a number of the fittest hypotheses to be transferred from current to new population (described below).

In step 210, method 200 can include mutating a portion of the new population.

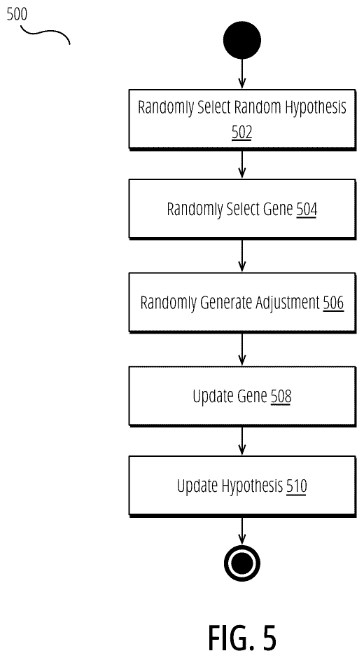

In some implementations, a mutation operator is used to introduce diversity into the new population. In some implementations, this may include randomly transforming a subset of solution hypotheses in the next population. As the result, mutation allows escaping local minima of the objective function (Equation 1) by introducing additional solution alternatives. Details of the mutation operator are provided in FIG. 5.

FIG. 5 is a flow diagram illustrating a method for mutating a population of hypotheses.

In step 502, method 500 can include randomly selecting a hypothesis. In some implementations, a hypothesis from a given population can be randomly selected. Alternatively, the selected hypothesis can be chosen using a selection operator (as described in step 208).

In step 504, method 500 can include randomly selecting a gene from the hypothesis selected in step 502. As discussed, a gene can be either a latitude or longitude value and step 504 can include selecting a random value from these pairs.

In step 506, method 500 can include generating an adjustment for the gene. In general, an adjustment refers to an amount to change the value of the gene. In one implementation, step 506 can use a normal distribution to generate an adjustment:

$$\frac{1}{σ \sqrt{2 π}} {e}^{- \frac{1}{2} {( \frac{x - μ}{σ} )}^{2}}$$

In this implementation, the mean or expectation of the normal distribution (μ) can be set to the value of the randomly selected gene while the width parameter a can be pre-configured. In some embodiments, the value of a can vary. For example, in one implementation, the width parameter a is gradually decreased as a function of iterations completed by the algorithm using. For example:

$$σ ( t ) = {{σ}_{i} ( \frac{{σ}_{f}}{{σ}_{i}} )}^{\frac{t}{{t}_{max}}} \qquad Equation 4$$

In Equation 4, σ(t) represents a function that gradually decreases based on a given iteration t. Here, σᵢ represents the initial width value (i.e., provided as a parameter of method 500), σ_{f} represents the width value when all iterations are complete, tₘₐₓ represents a total number of iterations, and t represents a current iteration (e.g., between 0 and tₘₐₓ−1).

In step 508, method 500 can include updating the original gene value using the adjustment. In some implementations, step 508 can include adding (or subtracting) the generated adjustment value from the original gene value to obtain a new gene value. In step 510, method 500 can include updating the hypothesis by, for example, persisting the new gene value in place of the original gene value.

Returning to step 210, method 200 can perform method 500 a set number of times. For example, method 200 can mutate

$$m \frac{P}{P - e}$$

times, where P is the current population size, e represents a number of the fittest hypotheses to be transferred from current to new population, and m is a tunable percentage of mutations.

In step 212, method 200 can include transferring the fittest subset of the population to a new population for a next iteration (if required). In general, the transferring of less than all of the new population is referred to as elitism. In some implementations, method 200 can compute a misfit value for each hypothesis in the new population (as discussed previously). Next, method 200 can select e hypotheses having the lowest misfit values for inclusion in a next iteration. In some implementations, the value of e can be tuned by the operator of method 200.

In step 214, method 200 determines if a stopping criterion is met. In general, the stopping criterion can include any metric that can deterministically indicate that generating new populations should stop. In one implementation, the stopping criterion can be a fixed number of iterations of method 200. Other stopping criteria may be used. If the stopping criterion is not met, method 200 continues to regenerate new populations starting at step 204.

In step 216, method 200 outputs the best hypothesis if the stopping criterion is met. In some implementations, method 200 can select the hypothesis having the lowest misfit value as the best hypothesis and output or store the best hypothesis for use by downstream applications.

In some implementations, after step 216, method 200 can include allocating at least one resource based on the best or winning hypothesis. A resource can include a sales representative, computer hardware, service, physical store, or any other type of resource or object that can be deployed, sent, or otherwise present in a geographic region. In some implementations, the winning hypothesis includes a set of latitude-longitude centroids of clusters. Thus, in some implementations, method 200 can allocate the resources by allocating a set of resources to each cluster. In some scenarios, method 200 can compute the expected demand for resources in each of the clusters and then allocate a fixed number of resources to each cluster based on the expected demand.

FIG. 7 is a block diagram of a computing device. The computing device 700 can be used to perform the methods described above or implement the components depicted in the foregoing figures.

As illustrated, the computing device 700 includes a processor or central processing unit (CPU) such as CPU 702 in communication with a memory 704 via a bus 714. The device also includes one or more input/output (I/O) or peripheral devices 712. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 702 may comprise a general-purpose CPU. The CPU 702 may comprise a single-core or multiple-core CPU. The CPU 702 may comprise a system-on-a-chip (SoC) or a similar embedded system. In some embodiments, a graphics processing unit (GPU) may be used in place of, or in combination with, a CPU 702. Memory 704 may comprise a non-transitory memory system including a dynamic random-access memory (DRAM), static random-access memory (SRAM), Flash (e.g., NAND Flash), or combinations thereof. In one embodiment, bus 714 may comprise a Peripheral Component Interconnect Express (PCIe) bus. In some embodiments, bus 714 may comprise multiple busses instead of a single bus.

Memory 704 illustrates an example of non-transitory computer storage media for the storage of information such as computer-readable instructions, data structures, program modules, or other data. Memory 704 can store a basic input/output system (BIOS) in read-only memory (ROM), such as ROM 708, for controlling the low-level operation of the device. The memory can also store an operating system in random-access memory (RAM) for controlling the operation of the device

Applications 710 may include computer-readable and computer-executable instructions which, when executed by the device, perform any of the methods (or portions of the methods) described previously in the description of the preceding Figures. In some embodiments, the software or programs implementing the method embodiments can be read from a hard disk drive (not illustrated) and temporarily stored in RAM 706 by CPU 702. CPU 702 may then read the software or data from RAM 706, process them, and store them in RAM 706 again.

The computing device 700 may optionally communicate with a base station (not shown) or directly with another computing device. One or more network interfaces in peripheral devices 712 are sometimes referred to as a transceiver, transceiving device, or network interface card (NIC).

An audio interface in peripheral devices 712 produces and receives audio signals such as the sound of a human voice. For example, an audio interface may be coupled to a speaker and microphone (not shown) to enable telecommunication with others or generate an audio acknowledgment for some action. Displays in peripheral devices 712 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 712 may comprise any input device arranged to receive input from a user. An illuminator in peripheral devices 712 may provide a status indication or provide light. The device can also comprise an input/output interface in peripheral devices 712 for communication with external devices, using communication technologies, such as USB, infrared, Bluetooth™, or the like. A haptic interface in peripheral devices 712 provides tactile feedback to a user of the client device.

A GPS receiver in peripheral devices 712 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown in FIG. 7, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, the claimed or covered subject matter is intended to be broadly interpreted. Among other things, for example, the subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment, and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms such as “or,” “and,” or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, can be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur in any order other than those noted in the illustrations. For example, two blocks shown in succession can, in fact, be executed substantially concurrently, or the blocks can sometimes be executed in the reverse order, depending upon the functionality or acts involved.

These computer program instructions can be provided to a processor of a general-purpose computer to alter its function to a special purpose; a special purpose computer; ASIC; or other programmable digital data processing apparatus, such that the instructions, which execute via the processor of the computer or other programmable data processing apparatus, implement the functions or acts specified in the block diagrams or operational block or blocks, thereby transforming their functionality in accordance with embodiments herein.

For the purposes of this disclosure, a computer-readable medium (or computer-readable storage medium) stores computer data, which data can include computer program code or instructions that are executable by a computer, in machine-readable form. By way of example, and not limitation, a computer-readable medium may comprise computer-readable storage media for tangible or fixed storage of data or communication media for transient interpretation of code-containing signals. Computer-readable storage media, as used herein, refers to physical or tangible storage (as opposed to signals) and includes without limitation volatile and non-volatile, removable, and non-removable media implemented in any method or technology for the tangible storage of information such as computer-readable instructions, data structures, program modules or other data. Computer-readable storage media includes, but is not limited to, RAM, ROM, EPROM, EEPROM, flash memory or other solid-state memory technology, CD-ROM, DVD, or other optical storage, magnetic cassettes, magnetic tape, magnetic disk storage, or other magnetic storage devices, or any other physical or material medium which can be used to tangibly store the desired information or data or instructions and which can be accessed by a computer or processor.

For the purposes of this disclosure, a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer-readable medium for execution by a processor. Modules may be integral to one or more servers or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than or more than all the features described herein are possible.

Functionality may also be, in whole or in part, distributed among multiple components, in manners now known or to become known. Thus, a myriad of software, hardware, and firmware combinations are possible in achieving the functions, features, interfaces, and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example to provide a complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

We claim:

1. A method comprising:
initializing a population of hypotheses;
computing misfit values for each of the hypotheses, the misfit values computed using a fitness function comprising a weighted summation, wherein terms of weighted summation comprise metric functions;
generating a plurality of offspring hypotheses based on the population of hypotheses and a crossover bitmask;
generating a new population using the plurality of offspring and a subset of the population of hypotheses;
mutating at least one hypothesis in the new population;
selecting a hypothesis from the new population based on a corresponding misfit value of the hypothesis; and
allocating at least one resource based on the hypothesis.

2. The method of claim 1, wherein initializing a population of hypotheses comprises generating a set of hypotheses, each hypotheses comprising a set of latitude-longitude pairs.

3. The method of claim 2, wherein each latitude-longitude pair in the set of latitude-longitude pairs comprises a randomized numeric latitude-longitude pair.

4. The method of claim 1, wherein the metric functions include a cluster quality function.

5. The method of claim 4, wherein the cluster quality function comprises one of a k-means objective function, Davies-Bouldin index, or Silhouette coefficient.

6. The method of claim 1, wherein generating a given offspring hypothesis comprises:
selecting two hypotheses from the population of hypotheses;
generating a random bitstring as the crossover bitmask; and
applying the random bitstring to each of the two hypotheses to generate two offspring hypotheses.

7. The method of claim 1, further comprising generating the subset of the population of hypotheses via tournament selection.

8. The method of claim 1, wherein mutating at least one hypothesis in the new population comprises adjusting a gene in the at least one hypothesis using a normal distribution.

9. The method of claim 8, wherein a width parameter of the normal distribution varies based on a number of iterations of mutation.

10. A non-transitory computer-readable storage medium for tangibly storing computer program instructions capable of being executed by a computer processor, the computer program instructions defining steps of:
initializing a population of hypotheses;
computing misfit values for each of the hypotheses, the misfit values computed using a fitness function comprising a weighted summation, wherein terms of weighted summation comprise metric functions;
generating a plurality of offspring hypotheses based on the population of hypotheses and a crossover bitmask;
generating a new population using the plurality of offspring and a subset of the population of hypotheses;
mutating at least one hypothesis in the new population;
selecting a hypothesis from the new population based on a corresponding misfit value of the hypothesis; and
allocating at least one resource based on the hypothesis.

11. The non-transitory computer-readable storage medium of claim 10, wherein initializing a population of hypotheses comprises generating a set of hypotheses, each hypotheses comprising a set of latitude-longitude pairs.

12. The non-transitory computer-readable storage medium of claim 11, wherein each latitude-longitude pair in the set of latitude-longitude pairs comprises a randomized numeric latitude-longitude pair.

13. The non-transitory computer-readable storage medium of claim 10, wherein the metric functions include a cluster quality function.

14. The non-transitory computer-readable storage medium of claim 13, wherein the cluster quality function comprises one of a k-means objective function, Davies-Bouldin index, or Silhouette coefficient.

15. The non-transitory computer-readable storage medium of claim 10, wherein generating a given offspring hypothesis comprises:
selecting two hypotheses from the population of hypotheses;
generating a random bitstring as the crossover bitmask; and
applying the random bitstring to each of the two hypotheses to generate two offspring hypotheses.

16. The non-transitory computer-readable storage medium of claim 10, further comprising generating the subset of the population of hypotheses via tournament selection.

17. The non-transitory computer-readable storage medium of claim 10, wherein mutating at least one hypothesis in the new population comprises adjusting a gene in the at least one hypothesis using a normal distribution.

18. The non-transitory computer-readable storage medium of claim 17, wherein a width parameter of the normal distribution varies based on a number of iterations of mutation.

19. A system comprising:
a processor; and
a storage medium for tangibly storing thereon program logic for execution by the processor, the stored program logic comprising instructions for:
initializing a population of hypotheses;
computing misfit values for each of the hypotheses, the misfit values computed using a fitness function comprising a weighted summation, wherein terms of weighted summation comprise metric functions;
generating a plurality of offspring hypotheses based on the population of hypotheses and a crossover bitmask;
generating a new population using the plurality of offspring and a subset of the population of hypotheses;
mutating at least one hypothesis in the new population;
selecting a hypothesis from the new population based on a corresponding misfit value of the hypothesis; and
allocating at least one resource based on the hypothesis.

20. The system of claim 19, wherein the metric functions include a cluster quality function and at least one of a density balance function and key performance indicator function.
